(19) United States
(12) Patent Application Publication
(10) Pub. No.: US 2014/0190852 A1
(43) Pub. Date: Jul. 10, 2014

(54) TWO-PIECE FOLDED TOOL BAG

(71) Applicant: LF Centennial Ltd., Road Town (VG)

(72) Inventors: Terrence P. Kinskey, Alpharetta, GA (US); Matthew G. Williams, Lighthouse Point, FL (US)

(73) Assignee: LF Centennial Ltd., Road Town (VG)

(21) Appl. No.: 14/152,308

(22) Filed: Jan. 10, 2014

Related U.S. Application Data
(60) Provisional application No. 61/751,014, filed on Jan. 10, 2013.

(51) Int. Cl. B25H 3/02

(52) U.S. Cl. CPC B25H 3/022
USPC 206/374; 206/373; 29/428

(57) ABSTRACT

A two-piece folded tool bag is described. The tool bag includes a tool bag body including an open topped storage volume formed from a primary blank including a first sidewall panel and a second sidewall panel joined to opposite edges of a primary base panel, and a secondary blank including a third sidewall panel and a fourth sidewall panel joined to opposite edges of a secondary base panel. The primary base panel overlaps with the secondary base panel and a plurality of attachment panels attach adjacent sidewall panels.

### CROSS-REFERENCE TO RELATED APPLICATIONS

This application claims priority to U.S. Provisional Application No. 61/751,014, filed Jan. 10, 2013, the entirety of which is incorporated herein by reference.

### FIELD OF THE INVENTION

The present invention relates generally to the field of bags, and more particularly to a multi-function tool bag that is useful for carrying and storing tools.

### BACKGROUND

Tool carriers are known to be useful for workers needing to transport tools to and from a work site for a specific job. Conventional tool carriers often include expensive and time-consuming assembly, for example by requiring complex injection molding machinery or detailed sewing that must be completed by hand. Such costly or inefficient techniques are also often required to assemble and insert tool carrier features such as pockets, sleeves, etc. While conventional tool carriers are useful in some instances, there are still numerous deficiencies and the potential for more useful and efficiently assembled tool carriers and tool carrier features.

### SUMMARY

A tool bag is described herein. The tool bag can include a tool bag body with an open topped storage volume formed from a primary blank, a secondary blank and a plurality of attachment panels. The primary blank can include a first sidewall panel joined to a primary base panel along a first base hinge line and a second sidewall panel joined to an opposite edge of the primary base panel along a second base hinge line parallel to the first base hinge line. The secondary blank can include a third sidewall panel joined to a secondary base panel along a third base hinge line and a fourth sidewall panel joined to an opposite edge of the secondary base panel along a fourth base hinge line parallel to the third base hinge line. Each of the attachment panels can be joined to one of the sidewalls along a longitudinally extending attachment hinge line. The primary base panel can overlap with the secondary base panel, with the first and second base hinge lines perpendicular to the third and fourth base hinge lines, and the plurality of attachment panels can overlap with and attach to adjacent sidewall panels.

The primary and secondary base panels can be substantially square and substantially a same size. The primary and secondary blanks can also include inner and outer flexible layers and at least one rigid support member disposed between the inner and outer flexible layers. The primary and secondary blanks can also include a plurality of rigid support members disposed between the inner and outer flexible layers, with the base hinge lines positioned in gaps between adjacent rigid support members. The inner and outer flexible layers can be coupled along edges of each layer. At least one of the sidewalls can also include a plurality of pockets. The tool bag can also include a handle attached to at least one of the sidewalls.

In one arrangement, the plurality of attachment panels can include a first attachment panel joined to the first sidewall panel along a first longitudinally extending attachment hinge line perpendicular the first base hinge line, a second attachment panel joined to the second sidewall panel along a second longitudinally extending attachment line perpendicular the second base hinge line, a third attachment panel joined to the third sidewall panel along a third longitudinally extending attachment line perpendicular the third base hinge line, and a fourth attachment panel joined to the fourth sidewall panel along a fourth longitudinally extending attachment line perpendicular the fourth base hinge line. The first attachment panel can overlap with and attach to the third sidewall panel, the third attachment panel can overlap with and attach to the second sidewall panel, the second attachment panel can overlap with and attach to the fourth sidewall panel, and the fourth attachment panel can overlap with and attach to the first sidewall panel.

In another arrangement, the plurality of attachment panels can include a first attachment panel joined to the first sidewall panel along a first longitudinally extending attachment hinge line perpendicular the first base hinge line, a second attachment panel joined to the first sidewall panel along a second longitudinally extending attachment hinge line opposite and parallel the first longitudinally extending attachment hinge line, a third attachment panel joined to the second sidewall panel along a third longitudinally extending attachment hinge line perpendicular the second base hinge line, and a fourth attachment panel joined to the second sidewall panel along a fourth longitudinally extending attachment hinge line opposite and parallel the third longitudinally extending attachment hinge line. Each of the first attachment panel and the third attachment panel can overlap with and attach to the third sidewall panel, and each of the second attachment panel and the fourth attachment panel can overlap with and attach to the fourth sidewall panel. The plurality of attachment panels can also be permanently attached to the adjacent side panels.

In another example, the tool bag includes a tool bag body with an open topped storage volume formed from a primary blank, a secondary blank, and first, second, third and fourth attachment panels. The primary blank can include a first sidewall panel joined to a primary base panel along a first base hinge line and a second sidewall panel joined to the primary base panel along a second base hinge line opposite and parallel the first base hinge line. The secondary blank can include a third sidewall panel joined to a second base panel along a third base hinge line, a fourth sidewall panel joined to the second base panel along a fourth base hinge line opposite and parallel the third base hinge line. The primary base panel can overlap with the secondary base panel with the first and second base hinge lines perpendicular to the third and fourth base hinge lines; and the first attachment panel can attach the first and third sidewall panels in an orientation perpendicular to the base panels, the second attachment panel can attach the first and fourth sidewall panels in an orientation perpendicular to the base panels, the third attachment panel can attach the second and third sidewall panels in an orientation perpendicular to the base panels, and the fourth attachment panel can attach the second and fourth sidewall panels in an orientation perpendicular to the base panels.

The tool bag can also include at least one tool receptacle attached to at least one of the sidewall panels. For example, the at least one tool receptacle can be attached to only one sidewall panel or the at least one tool receptacle can be attached to opposing sidewall panels and extend across the tool bag body. In embodiments that include the primary and secondary blanks having inner and outer flexible layers and a rigid support member disposed between the inner and outer flexible layers, the tool receptacle can also attach to the inner flexible layer on one or more sidewall panels. The tool receptacle can include receptacle walls comprising ethylene vinyl acetate. The tool receptacle can also be a removable tool receptacle.

A method of assembling a tool bag is also described herein. The method includes providing a primary blank and providing a secondary blank. The primary blank can include a first sidewall panel joined to a primary base panel along a first base hinge line and a second sidewall panel joined to the primary base panel along a second base hinge line opposite and parallel the first base hinge line. The secondary blank can include a third sidewall panel joined to a secondary base panel along a third base hinge line, a fourth sidewall panel joined to the secondary base panel along a fourth base hinge line opposite and parallel the third base hinge line. The method can also include overlapping the primary base panel with the secondary base panel with the first and second base hinge lines are perpendicular to the third and fourth base hinge lines; folding the sidewall panels along the base hinge lines to orient the sidewall panels perpendicular to the base panels; and attaching adjacent sidewall panels with a plurality of attachment panels to form a tool bag body with an open topped storage volume.

The method can also include overlapping the attachment panels with at least one of the sidewall panels when attaching adjacent sidewall panels with the attachment panels. The attachment panels can also include a first attachment panel, a second attachment panel, a third attachment panel and a fourth attachment panel joined to the sidewalls of the primary blank or the second blank along longitudinally extending attachment hinge lines.

These and other features, objects and advantages of the present invention will become more apparent to one skilled in the art from the following description and claims when read in light of the accompanying drawings.

### BRIEF DESCRIPTION OF THE DRAWINGS

FIG. 1 is a perspective view of a tool bag described herein.

FIG. 2 is a front view of the tool bag of FIG. 1.

FIG. 3 is a side view of the tool bag of FIG. 1.

FIG. 4 is a top view of the tool bag of FIG. 1.

FIG. 5 is a bottom view of the tool bag of FIG. 1.

FIG. 6 is a cross-section view along diagonal cut-line 6-6 of the tool bag of FIG. 1.

FIG. 6A is a close-up view of the circled area of FIG. 6.

FIG. 7A is an exploded view of a tool bag body described herein.

FIG. 7B is an assembled view of the tool bag of FIG. 7A.

FIG. 8A is an exploded view of a tool bag body described herein.

FIG. 8B is an assembled view of the tool bag of FIG. 8A.

FIG. 9A is an exploded view of a tool bag body and a tool receptacle described herein.

FIG. 9B is an assembled view of the tool bag of FIG. 9A.

### DETAILED DESCRIPTION

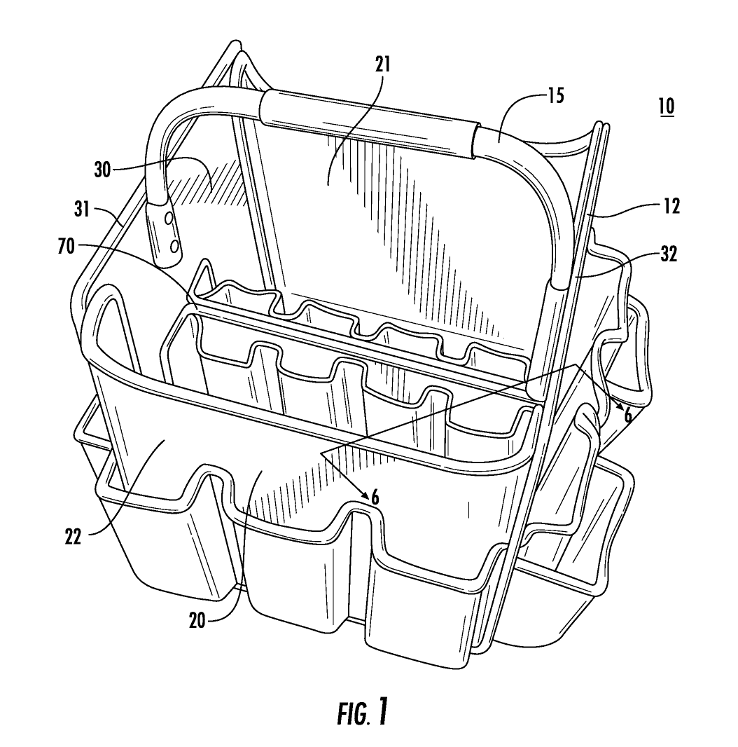

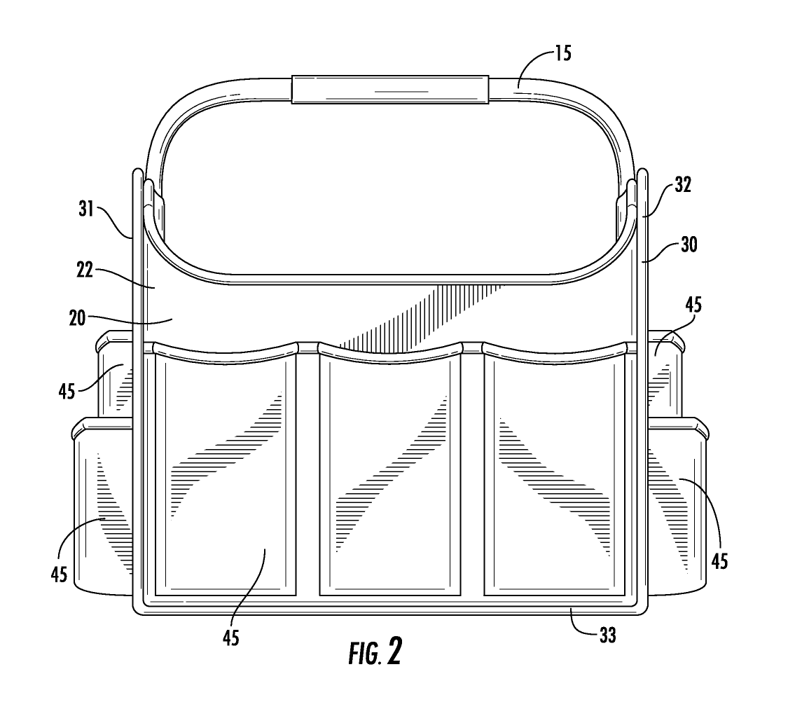

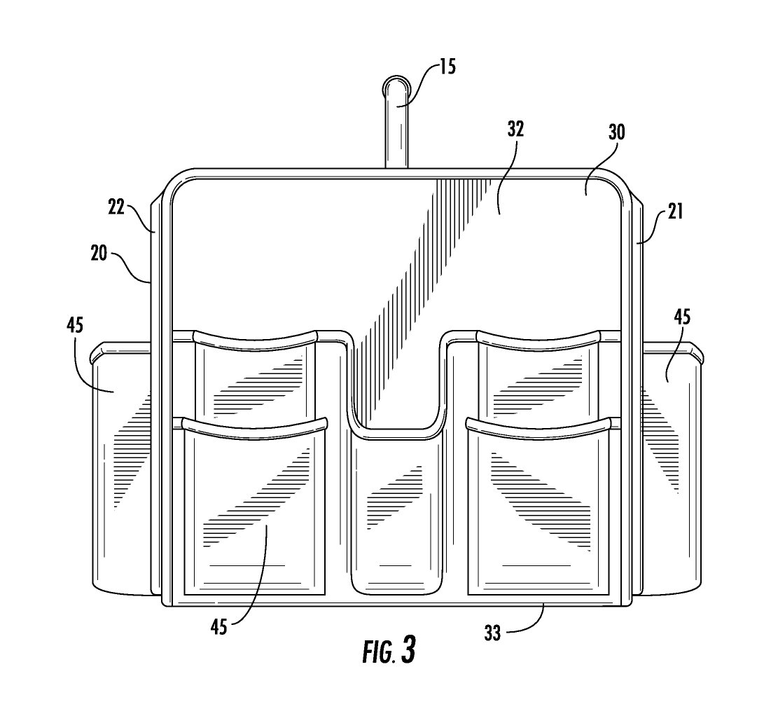

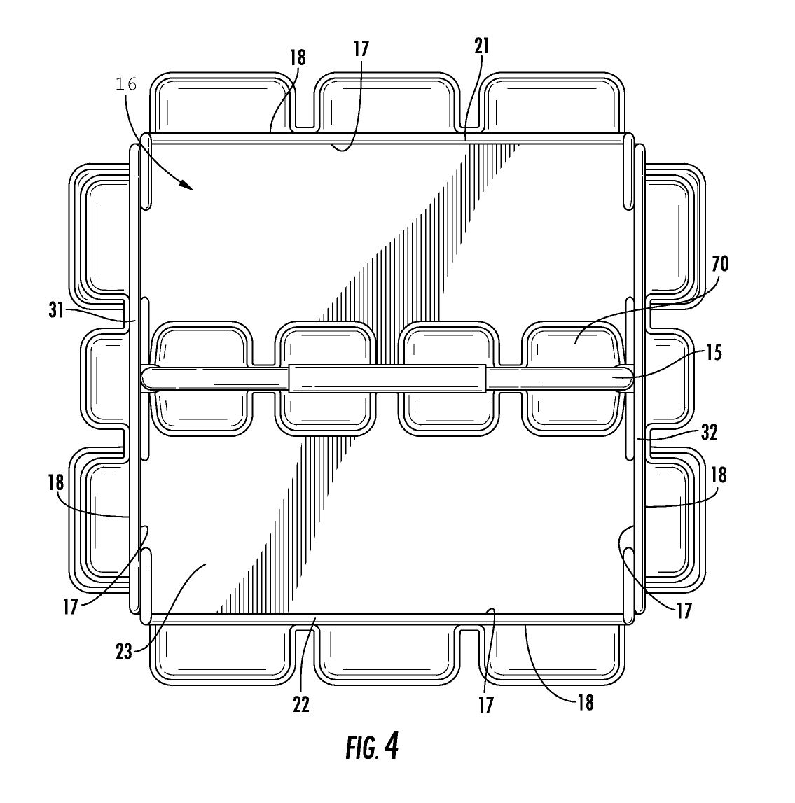

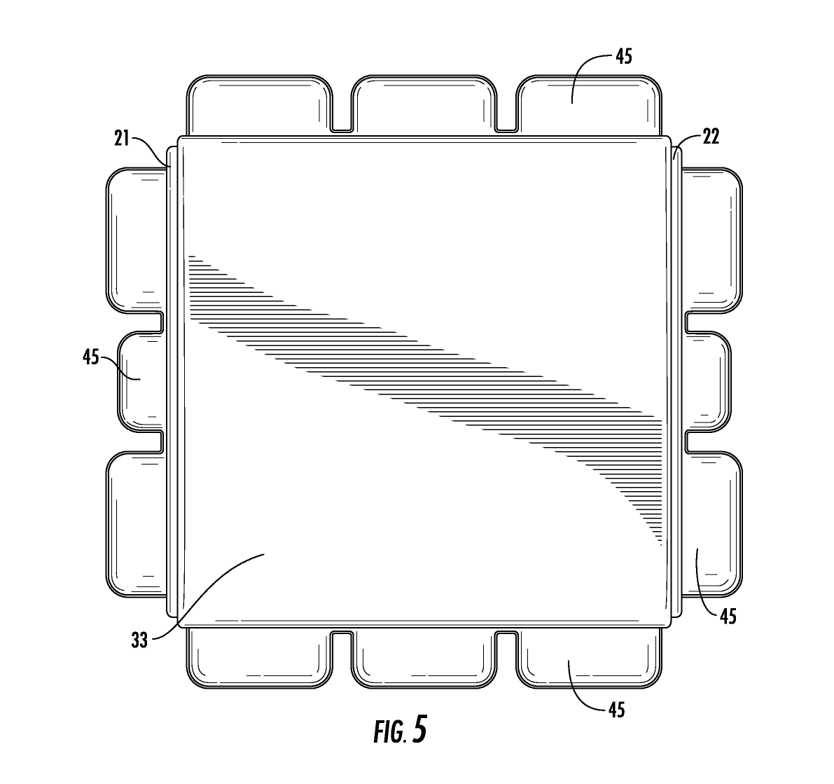

As shown in FIGS. 1-9B, a tool bag 10 with a tool bag body 12 formed from a primary blank 20 and a secondary blank 30 is described. The tool bag body 12 is configured to hold a variety of tools for easy storage, transport and access when working on a project.

The tool bag 10 and methods described herein provide for more efficient and effective production and assembly of tool bags. In particular, the primary and secondary blanks 20, 30 can include a quick folding assembly to form a base and sidewalls for a tool bag body 12 including an open topped storage volume 16, as shown in FIGS. 1-5. For additional storage and organization, the tool bag body 12 can include additional tool holders 45 for attachment to a sidewall and/or tool receptacles 70 for attachment within the tool bag body 12. Any of the blanks 20, 30, additional tool holders 45 and/or tool receptacles 70 can be pre-formed for more efficient bag assembly and uniform construction.

Assembly can include providing two pieces—a primary blank 20 and secondary blank 30. The primary blank 20 can include a first sidewall panel 21 joined to a primary base panel 23 along a first base hinge line 25 and a second sidewall panel 22 joined to the primary base panel 23 along a second base hinge line 26. The second base hinge line 26 is opposite and parallel to the first base hinge line 25. The secondary blank 30 can include a third sidewall panel 31 joined to a secondary base panel 33 along a third base hinge line 35 and a fourth sidewall panel 32 joined to the second base panel 33 along a fourth base hinge line 36. The fourth base hinge line 36 is opposite and parallel to the third base hinge line 35.

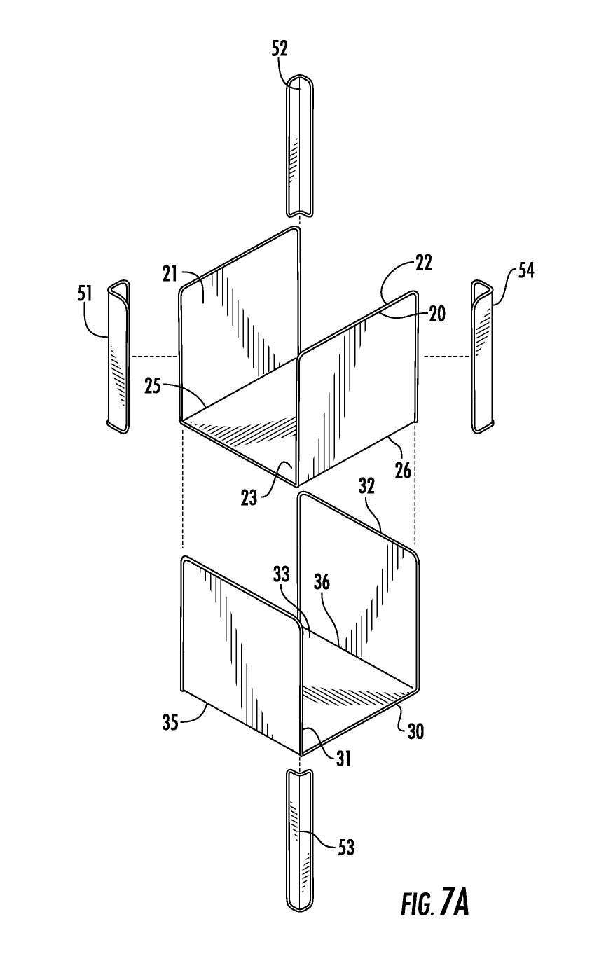

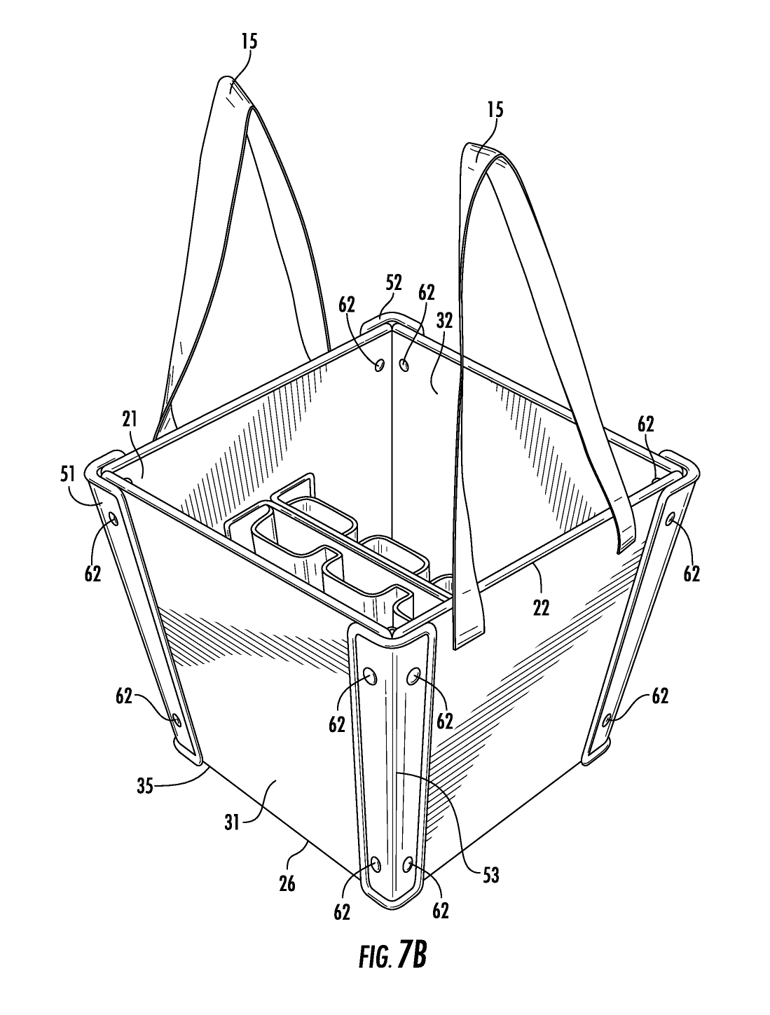

As shown in FIGS. 7A-9B, assembly can include overlapping the primary base panel 23 of the primary blank 20 with the secondary base panel 33 of the secondary blank 30, with the first and second base hinge lines 25, 26 positioned perpendicular to the third and fourth base hinge lines 35, 36. The sidewall panels 21, 22, 31, 32 can be folded along the base hinge lines 25, 26, 35, 36 to orient the sidewall panels 21, 22, 31, 32 perpendicular to the base panels 23, 33. The adjacent sidewall panels 21, 22, 31, 32 can then be attached to one another to form the tool bag body 12.

Additional tool holders 45, such as clips, prongs, sleeves and pockets, can be attached to at least one of the sidewalls 21, 22, 31, 32 of the tool bag body 12. For example a plurality of pockets 45 can be attached on an outer side 18 or an inner side 17 of the sidewall(s). One or more tool receptacles 70 can also be attached within the tool bag body 12. As used herein, “tool receptacle” refers to a receptacle configured to receive and store a tool. The tool receptacles 70 can include, without limitation compartments, subcompartments, trays, walls of sleeves and/or pockets, and combinations thereof. The tool receptacle 70 can be removable or permanently fixed to the tool bag body 12

The additional tool holders 45 and the tool receptacles 70 can also be pre-formed for quicker assembly and attachment. Pre-forming elements can include high-speed and automatic techniques such as thermoforming plastics or other molding processes that avoid the increased time and costs associated with conventional hand assembly (e.g., hand sewn components). For example, the additional tool holders 45 and the tool receptacles 70 can include thermo-formed ethylene vinyl acetate (EVA). As shown in FIGS. 1-5, the additional tool holders 45 can include a row of thermo-formed EVA pockets attached to an outer side 18 of each sidewall panel 21, 22, 31, 32. As shown in FIGS. 1-4, 9A and 9B, the tool receptacle 70 can include two rows of thermo-formed EVA pockets 70a, 70b attached to each other and the receptacle 70 can be attached to an inner side 17 of opposing sidewall panels 31/32.

The additional tool holders 45 and tool receptacles 70 can also include walls formed from other materials and processes, such as, but not limited to, thermoplastics, thermoset plastics, fabric, wood, metals, and similar materials.

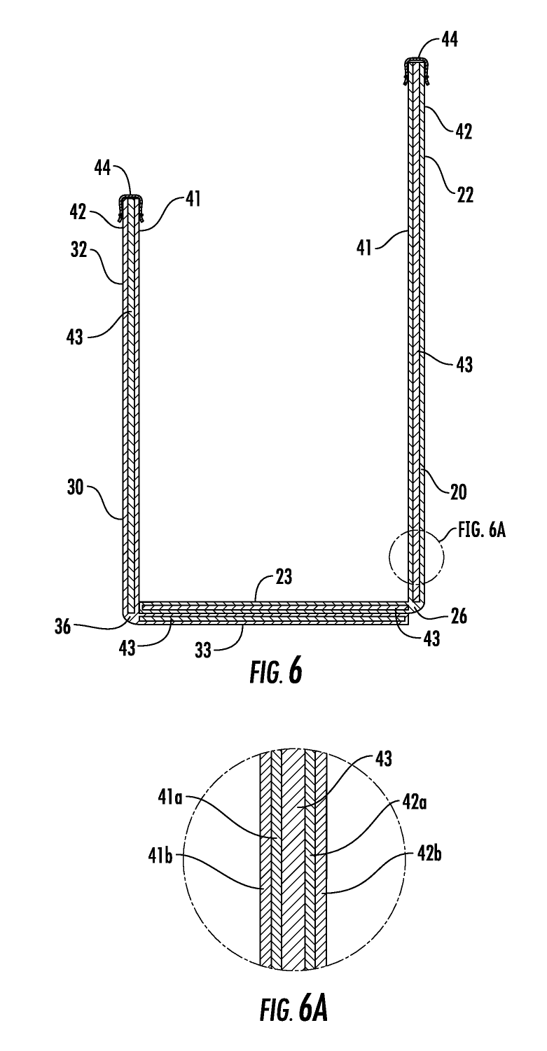

As shown in FIG. 6, the primary and secondary blanks 20, 30 can also include an inner flexible layer 41, an outer flexible layer 42 and at least one rigid support member 43 disposed between the inner and outer flexible layers 41, 42. Each blank 20, 30 can also include more than one rigid support member 43 and the base hinge lines 25, 26, 35, 36 can be located in gaps between adjacent rigid support members 43. The inner flexible layer 41 and the outer flexible layer 42 can be coupled along base hinge lines 25,26, 35, 36. In some embodiments, one or more of the sidewalls 25, 26, 35, 36 and base panels 23, 33 can include a single rigid support member 43 that extends to the edges or proximate the edges thereof.

The inner and outer flexible layers 41, 42 can be continuous over the entire blank 20, 30. The inner and outer flexible layers 41, 42 can also be coupled along edges of each layer 41, 42. For example, the inner and outer flexible layers 41, 42 can be coupled with a binding 44 along the edges of each layer 41, 42. The inner and outer flexible layers 41, 42 of the blanks 20, 30 can include any materials suitable for tool bags, such as fabric, e.g. nylon or canvas; plastic; leather; or combinations thereof, e.g. plastic reinforced fabric. Exemplary plastic reinforced fabric materials include those sold under the SPUNTUFF® trademark.

The rigid support member 43 can include any suitable material, including, but not limited to, plastic, e.g. polyethylene (PE), polypropylene (PP), polystyrene (PS), polyesters; other durable polymer materials; metal, e.g. steel; particle board; wooden planks or sheets; and combinations thereof, e.g. particle board disposed between polypropylene sheets. For example, the blanks 20, 30 can include a rigid support member 43 of 3.0 mm PE board covered by inner and outer flexible layers 41, 42. The inner and outer flexible layers 41, 42 can include a foam, a fabric, or both. For example as shown in FIG. 6A, the inner and outer flexible layers 41, 42 can include an EVA layer 41a, 42a (e.g., an EV foam) and a fabric 41b, 42b, such as 600D fabric, with the EV foam proximate the rigid support member 43. The inner and outer flexible layers 41, 42 can be coupled along their edges with binding (e.g., a fabric binding as shown in FIG. 6).

As shown in FIGS. 7A, 8A and 9A, the primary base panel 23 can overlap with the secondary base panel 33 with the first and second base hinge lines 25, 26 perpendicular to the third and fourth base hinge lines 35, 36. The primary and secondary base panels 23, 33 can be substantially the same size and substantially the same shape. For example the primary and secondary base panels 23, 33 can include a square shape or a rectangular shape. When the primary and secondary base panels 23, 33 are overlapped, the sidewall panels 21, 22, 31, 32 extending from each base panel 23, 33 can moved into an upright position generally perpendicular to the base panels 23, 33 by folding the blanks 20, 30 along each of the base hinge lines 25, 26, 35, 36 as shown in FIGS. 7A-9B to provide the open topped storage volume 15 of the tool bag 10.

The tool bag body 12 can also include a plurality of attachment panels 51, 52, 53, 54, including first, second, third and fourth attachment panels. The first attachment panel 51 can attach the first and third sidewall panels 21, 31 in an orientation perpendicular to the base panels 23, 33. The second attachment panel 52 can attach the first and fourth sidewall panels 21, 32 in an orientation perpendicular to the base panels 23, 33. The third attachment panel 53 can attach the second and third sidewall 22, 31 panels in an orientation perpendicular to the base panels 23, 33, and the fourth attachment panel 54 can attach the second and fourth sidewall panels 22, 32 in an orientation perpendicular to the base panels 23, 33.

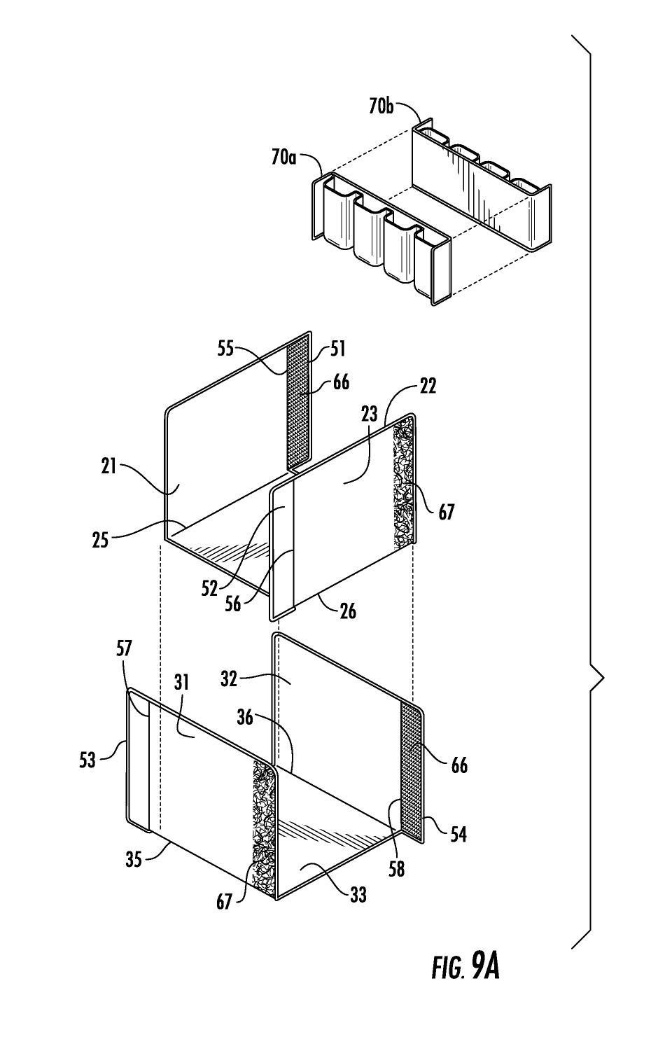

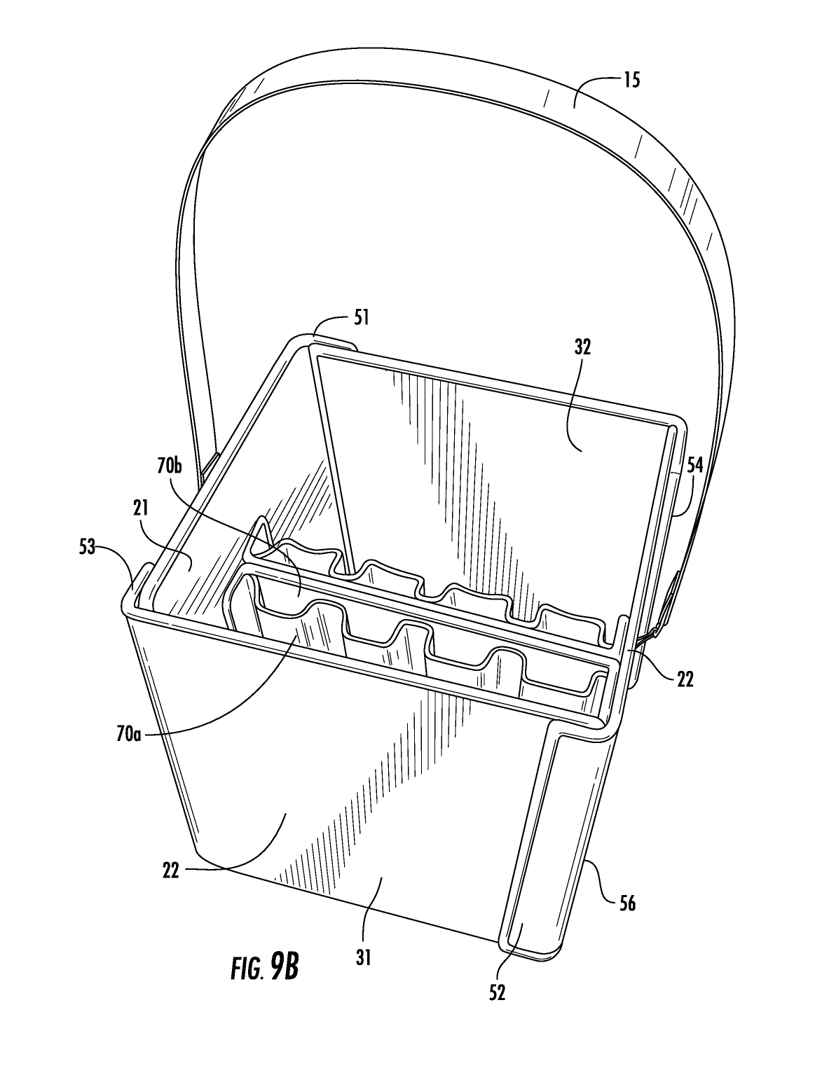

The attaching of the attachment panels 51, 52, 53, 54 to adjacent sidewall panels 21, 22, 31, 32 can be permanent or removable. Permanent fasteners 62 can include rivets, stitching, or adhesives. For example, rivets 62 can attach each attachment panel 51, 52, 53, 54 to a sidewall panel 21, 22, 31, 32 as shown in FIG. 7B. Removable fasteners 66, 67 can include hook and loop fasteners, zip fasteners, snaps, or inserting at least a portion of an attachment panel into a receiving portion on a sidewall panel. For example as shown in FIG. 9A, the attachment panels 51, 52, 53, 54 can include hook portions 66 and the sidewall panels 21, 22, 31, 32 can include corresponding loop portions 67, or vice versa.

The attachment panels 51, 52, 53, 54 can be separate from or integral with the sidewall panels 21, 22, 31, 32. When integral, each of the attachment panels 51, 52, 53, 54 can be joined to one of the sidewall panels 21, 22, 31, 32 along a longitudinally extending attachment hinge line 55, 56, 57, 58. As used herein, “longitudinally extending” refers to the direction of an edge shared by sidewall panels of a blank 20, 30. The plurality of attachment panels 51, 52, 53, 54 can overlap with, and attach to, adjacent sidewall panels 21, 22, 31, 32. As used herein, an “adjacent sidewall panel” refers to the sidewall panel to which an attachment panel is most proximate but not joined when the blanks 20, 30 are arranged with the base panels 23, 33 aligned. For example, if an attachment panel 51, 52, 53, 54 is joined to the first or second sidewall panel 21, 22, one of the third and fourth sidewalls 31, 32 can be the adjacent sidewall panel; or if an attachment panel 51, 52, 53, 54 is joined to the third or fourth sidewall panel 31, 32, one of the second and first sidewalls 21, 22 can be the adjacent sidewall panel.

The attachment panels 51, 52, 53, 54 can overlap with the adjacent sidewall panels 21, 22, 31, 32 on an outer side 18 of the sidewall panel 21, 22, 31, 32 or on an inner side 17 of the sidewall panel 21, 22, 31, 32. As used herein, “inner side” with respect to tool bag body features refers to the side most proximate to the storage volume of the assembled tool bag body. “Outer side” with respect to tool bag body features refers to the side least proximate to the storage volume. The overlapping of the primary base panel 23 and the secondary base panel 33 can include the primary base panel 23 on top of the secondary base panel 33 or the secondary base panel 33 on top of the primary base panel 23.

In the arrangement shown in FIGS. 9A and 9B, each of the plurality of attachment panels 51, 52, 53, 54 can be joined to a different sidewall panel 21, 22, 31, 32. The first attachment panel 51 can be joined to the first sidewall panel 21 along a first longitudinally extending attachment hinge line 55, the second attachment panel 52 can be joined to the second sidewall panel 22 along a second longitudinally extending attachment line 56, the third attachment panel 53 can be joined to the third sidewall panel 31 along a third longitudinally extending attachment line 57, and the fourth attachment panel 54 can be joined to the fourth sidewall panel 32 along a fourth longitudinally extending attachment line 58. Each of the longitudinally extending attachment hinge lines 55, 56, 57, 58 can be perpendicular to the base hinge lines 25, 26, 35, 36. Each attachment panel 51, 52, 53, 54 overlaps with and attaches to the adjacent sidewall panel 21, 22, 31, 32. For example, the first attachment panel 21 overlaps with and is attached to the third sidewall panel 31, the third attachment panel 53 overlaps with and is attached to the second sidewall panel 22, the second attachment panel 52 overlaps with and is attached to the fourth sidewall panel 32, and the fourth attachment panel 54 overlaps with and is attached to the first sidewall panel 21.

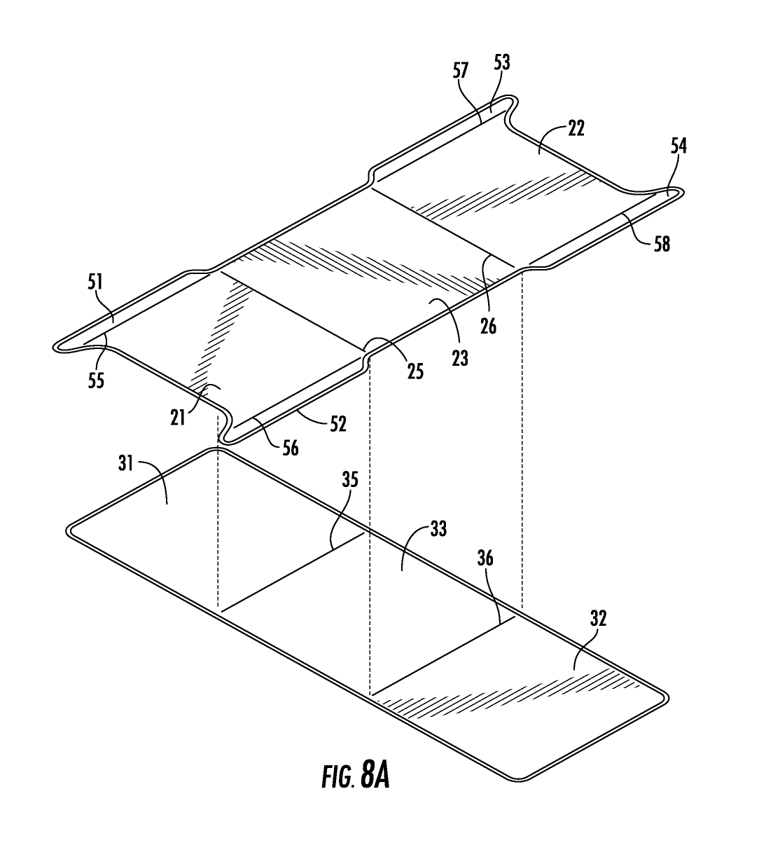

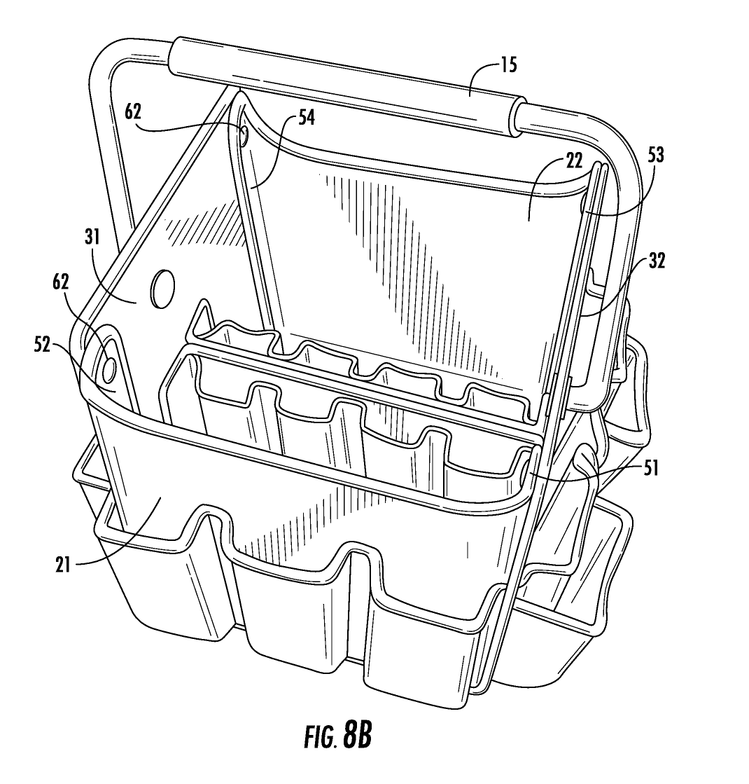

In the arrangement shown in FIGS. 8A and 8B, more than one attachment panel 51, 52, 53, 54 can be joined to the same sidewall panel 21, 22, 31, 32. The first attachment panel 21 can be joined to the first sidewall panel 21 along a first longitudinally extending attachment hinge line 55, and the second attachment panel 52 can be joined to the first sidewall panel 21 along a second longitudinally extending attachment hinge line 56 opposite and parallel to the first longitudinally extending attachment hinge line 55. The third attachment panel 53 can be joined to the second sidewall panel 22 along a third longitudinally extending attachment hinge line 57, and the fourth attachment panel 54 can be joined to the second sidewall panel 22 along a fourth longitudinally extending attachment hinge line 58 opposite and parallel the third longitudinally extending attachment hinge line 57. Each of the longitudinally extending attachment hinge lines 55, 56, 57, 58 can be perpendicular to the base hinge lines 25, 26, 35, 36. Each of the first attachment panel 51 and the third attachment panel 53 can overlap with and attach to the third sidewall panel 31, and each of the second attachment panel 52 and the fourth attachment panel 54 overlap with and attach to the fourth sidewall panel 32. As such, the plurality of attachment panels 51, 52, 53, 54 are joined to the sidewalls 21, 22 of the primary blank 20. Alternatively, the plurality of attachment panels 51, 52, 53, 57 can extend from sidewalls 21, 22 of the primary blank 20 and be joined to the sidewalls 31, 32 of the secondary blank 30.

The tool bag 10 can also include a handle 15 for carrying the tool bag 10 attached to at least one of the sidewalls 21, 22, 31, 32. The handle 15 can attach to one or more sidewalls 21, 22, 31, 32, including attaching to two sidewalls such as two opposing sidewalls, e.g. 21/22 or 31/32. As shown in FIG. 1, the handle 15 can attach to an inner side 17 of opposing sidewalls 31/32 and extend across and over the storage volume of the tool bag body 12. As shown in FIG. 8B, the handle 15 can extend from an outer side 18 of opposing sidewalls 31/32 and include a generally C-shaped handle. The handle 15 can also be rotatable. As shown in FIG. 9B, the handle 15 can include a carrying strap that can attach to opposing sidewalls 31/32. As shown in FIG. 6B the handle 15 can also include two separate handles 15, 15, each attached to opposing sidewalls 31/32. The two handles 15 can be brought together such that a user can grip both handles 15, 15 in one hand for transporting the tool bag 10. The handle 15 can be quickly attached during assembly such as by rivets or stitching.

Each of the features of the tool bag describe above provide a significant improvement over conventional tool bag construction, including the efficient two-piece folding assembly and the quick insertion and attachment of the thermo-formed EVA holders and receptacles, avoiding the additional time and cost required by the conventional hand stitching attachment for holders and receptacles. The tool bag and methods provide for a more efficient and effective assembly while maintaining good quality and appearance of the bags. Additionally, the overlapping base panels provide a sturdy double layered bottom for the tool bag, providing support for heavy tools stored in the bag.

The foregoing is provided for purposes of illustrating, explaining, and describing embodiments of this invention. Modifications and adaptations to these embodiments will be apparent to those skilled in the art and may be made without departing from the scope or spirit of this invention.

What is claimed is:

1. A tool bag, comprising:
a tool bag body comprising an open topped storage volume formed from:
a primary blank comprising a first sidewall panel joined to a primary base panel along a first base hinge line and a second sidewall panel joined to an opposite edge of said primary base panel along a second base hinge line parallel to said first base hinge line,
a secondary blank comprising a third sidewall panel joined to a secondary base panel along a third base hinge line and a fourth sidewall panel joined to an opposite edge of said secondary base panel along a fourth base hinge line parallel to said third base hinge line, and
a plurality of attachment panels, each of said attachment panels joined to one of said sidewalls along a longitudinally extending attachment hinge line;
wherein said primary base panel overlaps with said secondary base panel and said first and second base hinge lines are perpendicular to said third and fourth base hinge lines, and said plurality of attachment panels overlap with and attach to adjacent sidewall panels.

2. The tool bag according to claim 1, wherein said plurality of attachment panels comprise:
a first attachment panel joined to said first sidewall panel along a first longitudinally extending attachment hinge line perpendicular said first base hinge line,
a second attachment panel joined to said second sidewall panel along a second longitudinally extending attachment line perpendicular said second base hinge line,
a third attachment panel joined to said third sidewall panel along a third longitudinally extending attachment line perpendicular said third base hinge line, and
a fourth attachment panel joined to said fourth sidewall panel along a fourth longitudinally extending attachment line perpendicular said fourth base hinge line;
wherein said first attachment panel overlaps with and is attached to said third sidewall panel, said third attachment panel overlaps with and is attached to said second sidewall panel, said second attachment panel overlaps with and is attached to said fourth sidewall panel, and said fourth attachment panel overlaps with and is attached to said first sidewall panel.

3. The tool bag according to claim 1, wherein said plurality of attachment panels comprise:
a first attachment panel joined to said first sidewall panel along a first longitudinally extending attachment hinge line perpendicular said first base hinge line,
a second attachment panel joined to said first sidewall panel along a second longitudinally extending attachment hinge line opposite and parallel said first longitudinally extending attachment hinge line,
a third attachment panel joined to said second sidewall panel along a third longitudinally extending attachment hinge line perpendicular said second base hinge line, and
a fourth attachment panel joined to said second sidewall panel along a fourth longitudinally extending attachment hinge line opposite and parallel said third longitudinally extending attachment hinge line;
wherein each of said first attachment panel and said third attachment panel overlap with and attach to said third sidewall panel, and each of said second attachment panel and said fourth attachment panel overlap with and attach to said fourth sidewall panel.

4. The tool bag according to claim 1, wherein said plurality of attachment panels are permanently attached to said adjacent side panels.

5. The tool bag according to claim 1, wherein said primary and secondary base panels are substantially square and substantially a same size.

6. The tool bag according to claim 1, wherein each of said primary and secondary blanks further comprise inner and outer flexible layers and at least one rigid support member disposed between the inner and outer flexible layers.

7. The tool bag according to claim 6, wherein said inner and outer flexible layers are coupled along edges of each layer.

8. The tool bag according to claim 1, wherein each of said primary and secondary blanks further comprise inner and outer flexible layers and a plurality of rigid support members disposed between the inner and outer flexible layers, and said base hinge lines are positioned in gaps between adjacent rigid support members.

9. The tool bag according to claim 1, further comprising a handle attached to at least one of the sidewalls.

10. The tool bag according to claim 1, wherein at least one of the sidewalls further comprises a plurality of pockets.

11. A tool bag, comprising:
a tool bag body comprising an open topped storage volume formed from a primary blank, a secondary blank, and first, second, third and fourth attachment panels,
said primary blank comprising a first sidewall panel joined to a primary base panel along a first base hinge line and a second sidewall panel joined to said primary base panel along a second base hinge line opposite and parallel said first base hinge line, and
said secondary blank comprising a third sidewall panel joined to a second base panel along a third base hinge line, a fourth sidewall panel joined to said second base panel along a fourth base hinge line opposite and parallel said third base hinge line,
wherein said primary base panel overlaps with said secondary base panel and said first and second base hinge lines are perpendicular to said third and fourth base hinge lines, and wherein:
said first attachment panel attaches said first and third sidewall panels in an orientation perpendicular to said base panels,
said second attachment panel attaches said first and fourth sidewall panels in an orientation perpendicular to said base panels,
said third attachment panel attaches said second and third sidewall panels in an orientation perpendicular to said base panels, and
said fourth attachment panel attaches said second and fourth sidewall panels in an orientation perpendicular to said base panels.

12. The tool bag according to claim 11, further comprising at least one tool receptacle attached to at least one of the sidewall panels.

13. The tool bag according to claim 12, wherein said at least one tool receptacle is attached to only one sidewall panel.

14. The tool bag according to claim 12, wherein said at least one tool receptacle is attached to opposing sidewall panels and extends across the tool bag body.

15. The tool bag according to claim 12, wherein each of said primary and secondary blanks further comprise inner and outer flexible layers and a rigid support member disposed between the inner and outer flexible layers and said tool receptacle is attached to said inner flexible layer on each opposing sidewall panel.

16. The tool bag according to claim 12, wherein said at least one tool receptacle is a removable tool receptacle.

17. The tool bag according to claim 14, wherein said at least one tool receptacle comprises receptacle walls formed by ethylene vinyl acetate.

18. A method of assembling a tool bag, comprising:
providing a primary blank comprising a first sidewall panel joined to a primary base panel along a first base hinge line and a second sidewall panel joined to said primary base panel along a second base hinge line opposite and parallel said first base hinge line;
providing a secondary blank comprising a third sidewall panel joined to a secondary base panel along a third base hinge line, a fourth sidewall panel joined to said secondary base panel along a fourth base hinge line opposite and parallel said third base hinge line;
overlapping said primary base panel with said secondary base panel wherein said first and second base hinge lines are perpendicular to said third and fourth base hinge lines;
folding said sidewall panels along said base hinge lines to orient said sidewall panels perpendicular to said base panels; and
attaching adjacent sidewall panels with a plurality of attachment panels to form a tool bag body comprising an open topped storage volume.

19. The method according to claim 18, wherein the attaching step further comprises overlapping said attachment panels with at least one of said sidewall panels.

20. The method according to claim 18, wherein said attachment panels comprise a first attachment panel, a second attachment panel, a third attachment panel and a fourth attachment panel joined to the sidewalls of said primary blank or said second blank along longitudinally extending attachment hinge lines, and
the attaching step further comprises overlapping each of said attachment panels with an adjacent sidewall panel.
